(19) United States
(12) Patent Application Publication
(10) Pub. No.: US 2024/0119185 A1
(43) Pub. Date: Apr. 11, 2024

(54) CHANNEL WIDTH CONTROL FOR MULTI-ZONE MICROREACTOR FLOW FIELDS

(71) Applicant: Toyota Motor Engineering & Manufacturing North America, Inc., Plano, TX (US)

(72) Inventors: Sarah N. Hankins, Laramie, WY (US); Yuqing Zhou, Ann Arbor, MI (US); Ercan Dede, Ann Arbor, MI (US); Danny Lohan, Northville, MI (US)

(73) Assignees: Toyota Motor Engineering & Manufacturing North America, Inc., Plano, TX (US); Toyota Jidosha Kabushiki Kaisha, Toyota-Shi (JP)

(21) Appl. No.: 17/938,690

(22) Filed: Oct. 7, 2022

(51) Int. Cl. G06F 30/10

(52) U.S. Cl. CPC G06F 30/10; G06F 2113/08

(57) ABSTRACT

One or more multi-zoned microreactor flow field configurations that facilitate optimized reaction-fluid performance, and one or more methods of designing such multi-zoned microreactor flow fields.

### TECHNICAL FIELD

Embodiments relate generally to one or more multi-zoned microreactor flow field configurations that facilitate optimized reaction-fluid performance, and one or more methods of designing such multi-zoned microreactor flow fields.

### BACKGROUND

Computational efficiency, structural performance, and manufacturability continue to drive the field of topology optimization. In particular, the density-based method has become a standard in the field for research and industrial applications. The density-based method is capable of generating designs that meet both the loading and fabrication requirements for an array of applications in areas such as structural mechanics, fluid mechanics, and heat transfer.

Large giga-element design domains, such as bridges and airplane wings, however, require thousands of CPU cores (i.e., access to supercomputers) to execute the density-based topology optimization in an acceptable amount of time. As a result, numerous research efforts have been aimed at developing innovative approaches that can overcome this current limitation.

A homogenization method is a computationally efficient engineering design tool when paired with novel dehomogenization techniques. On its own, the homogenization method is known to be a numerically efficient approach to topology optimization. The homogenization method, however, is generally not used as a stand-alone design tool due to the complex solutions that cannot be easily manufactured. Recent research has focused on the inverse homogenization approach which solely optimizes the macroscopic properties, usually in the form of one or more scalar fields and a material orientation field.

Next, a separate dehomogenization tool can be used to design explicit microscale geometries that align with the optimized macroscale features. Such inverse design approach is appealing, because the homogenization-based optimization can be performed on a coarse mesh, reducing the computational cost, while the dehomogenization can be performed on a fine mesh to obtain explicit designs with intricate details.

Most dehomogenization methods, however, assemble unit cells with basic void geometric shapes (e.g., square, rectangular, circular, and crossbar) and orient them using the homogenized orientation field to form the final explicit microstructure geometry.

More recently, a new approach has emerged in the field of topology optimization which uses pattern generation algorithms, based on the seminal work by Alan Turing, to develop a diffusion-based class of bioinspired solutions. Many pattern generation algorithms are rooted in Turing's theory of a reaction-diffusion system that models the interaction of two chemical species (or morphogens). Mathematically, this model can be represented by a system of coupled partial differential equations (PDEs) that describe the evolution of the chemicals in both time and space. Reaction-diffusion models generally create patterns using the fundamental concept of local-activation and long-range inhibition (LACI). In the two-system model, the slowly diffusing activator morphogen promotes the production of itself along with the inhibitor morphogen. This creates regions with a high concentration of the activator species. The purpose of the rapidly diffusing inhibitor morphogen is to ensure that the high concentration regions are separated by a distance, defined by the diffusion rates of the two chemical species, which creates the formation of periodic patterns.

Reaction-diffusion models provide a clear and intuitive understanding of the LALI pattern generation mechanism. There is a simpler model, however, that encompasses the LALI mechanism in a single variable PDE known as the Swift-Hohenberg equation. The model takes advantage of the fact that the activator chemical in the reaction-diffusion system is the primary driver of the pattern generation process. This is because the morphogen not only activates itself locally, but it also indirectly inhibits itself due to the simultaneous production of the inhibitor morphogen.

The Swift-Hohenberg equation, therefore, models the cumulative effect of the local activation and long-range inhibition using a single variable PDE that evolves in time and space. Within the equation, a fourth order gradient operator is used to capture the long-range features, while a second order gradient operator is used to capture the short-range features. Despite its simplicity, the LALI logic embedded within the equation enables the model to produce periodic patterns similar to those found in the more complex reaction-diffusion systems. Nonetheless, it is worth noting that the equation is not capable of modeling all pattern generation phenomena, and in some cases more sophisticated models are required.

### BRIEF SUMMARY

One or more embodiments in accordance with this disclosure uses a steady-state pattern generation model as a computer-implemented rapid dehomogenization design method that yields multi-zone microreactor flow field designs.

Pattern generation models can exploit the anisotropic diffusion tensor such that structural elements emerge according to the prescribed orientation field. As a result, the process of diffusion promotes structures with a natural flow and a seamless transition between features despite the complexity of the design domain. These characteristics are geometrically distinct and can be difficult to achieve without a diffusion-based model. Intrinsically, diffusion is conceived as a process that evolves in time and space. It is natural, therefore, to solve bioinspired diffusion-based dehomogenization techniques in the same realm. The temporal process, however, can be computationally expensive and diminish the usefulness of the tool in a generative design type of application.

In accordance with one or more embodiments, to overcome the aforementioned barriers, the temporal domain is removed by directly solving the steady-state, single variable Swift-Hohenberg equation. This, in turn, revealed that a steady-state model is an order of magnitude faster than a transient model. To highlight the efficiency and uniqueness of the proposed technique, a Pareto front is developed, using a homogenization-based optimization routine to explore the design tradeoffs between pressure drop and reaction uniformity in microreactor flow fields. In total, a plurality of unique and distinctly different microchannel flow field designs may be created using the computer-implemented steady-state dehomogenization design method. The multi-zone microreactor flow field designs derived therefrom span the optimization space as well as the design space that is unique to the Swift-Hohenberg model.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

The various advantages of the embodiments of will become apparent to one skilled in the art by reading the following specification and appended claims, and by referencing the following drawings, in which:

FIG. 1 illustrates a microreactor design domain, in accordance with one or more embodiments set forth, described, and/or illustrated herein.

FIGS. 2A through 2C respectively illustrate a parameter adjustment in the Swift-Hohenberg model, in accordance with one or more embodiments set forth, described, and/or illustrated herein.

FIGS. 3A through 3E illustrate a comparison of steady-state versus transient Swift-Hohenberg model.

FIGS. 4A through 4E respectively illustrate microreactor flow field designs derived using single-objective optimization, in accordance with one or more embodiments set forth, described, and/or illustrated herein.

FIG. 5 is a table presenting Swift-Hohenberg model parameter settings for different types of microreactor flow field designs.

FIG. 6 is a graph that plots the normalized reaction variability versus flow resistance values for different weighting schemes defined within the objective function, in accordance with one or more embodiments set forth, described, and/or illustrated herein.

FIGS. 7A through 7C respectively illustrate results of the homogenization-based optimization routine for three different weighting schemes represented by “X” in the Pareto front in accordance with one or more embodiments set forth, described, and/or illustrated herein.

FIGS. 8A through 8D illustrate diffusion-based dehomogenized microchannel flow field designs for the three different weighting schemes represented by “X” in the Pareto front, each row representing a different design type defined by the Swift-Hohenberg parameter settings, in accordance with one or more embodiments set forth, described, and/or illustrated herein.

FIGS. 9A and 9B respectively illustrate overall computational time for the design of the microreactor flow fields using the computer-implemented steady-state dehomogenization design method.

FIG. 10 illustrates example microreactor flow field designs derived using the computer-implemented steady-state dehomogenization design method of an “optimal” design type, in accordance with one or more embodiments set forth, described, and/or illustrated herein.

FIG. 11 illustrates example microreactor flow field designs derived using the computer-implemented steady-state dehomogenization design method of a “parallel” design type, in accordance with one or more embodiments set forth, described, and/or illustrated herein.

FIG. 12 illustrates example microreactor flow field designs derived using the computer-implemented steady-state dehomogenization design method of a “wide” design type, in accordance with one or more embodiments set forth, described, and/or illustrated herein.

FIGS. 13A through 13C illustrate multi-zone microreactor flow field designs, in accordance with one or more embodiments set forth, described, and/or illustrated herein.

FIGS. 14A and 14B illustrate a microreactor design domain with subdomains of arbitrary shapes and sizes, in accordance with one or more embodiments set forth, described, and/or illustrated herein.

FIG. 15 illustrates a cross-sectional view of a fuel cell (FC) configuration that utilizes a multi-zone microreactor flow field, in accordance with one or more embodiments set forth, described, and/or illustrated herein.

FIG. 16 illustrates a diagram of a flow diagram of a method of designing a multi-zone microreactor flow field, in accordance with one or more embodiments set forth, described, and/or illustrated herein.

FIGS. 17 through 19 illustrate schematic diagrams of example methods of designing microchannel fluid flow networks in a fuel cell bipolar plate, in accordance with one or more embodiments set forth, described, and/or illustrated herein.

### DETAILED DESCRIPTION

Multi-Objective Optimization

One or more embodiments of this disclosure considers the present multi-objective optimization problem of flow resistance (pressure drop) versus reaction uniformity, common in the design of microreactors. A gradient-based anisotropic porous media method is used to generate the optimized orientation field for the computer-implemented steady-state dehomogenization design method disclosed herein.

A method in accordance with one or more embodiments initially optimizes a material orientation at each point in space by mapping the design variables to an orientation tensor. Next, an anisotropic porous medium permeability tensor is rotated according to the prescribed material orientation. Lastly, a laminar fluid flow through the porous media is analyzed using the Stokes equations, Darcy's law, and a convection-diffusion-reaction equation. The design variables are updated based on the optimization constraints and the objective function, which is given by the following:

$$F = {w}_{1} {f}_{1} + {w}_{2} {f}_{2} , \qquad ( 1 )$$

$${f}_{1} = {\int }_{{Ω}_{r}} {( \frac{c - {c}_{a v g}}{{c}_{a v g}} )}^{2} d {Ω}_{r} , \qquad ( 2 )$$

$${f}_{2} = \frac{1}{2} {\int }_{Ω} ∇ v \cdot ( ∇ v + {( ∇ v )}^{T} ) d Ω . \qquad ( 3 )$$

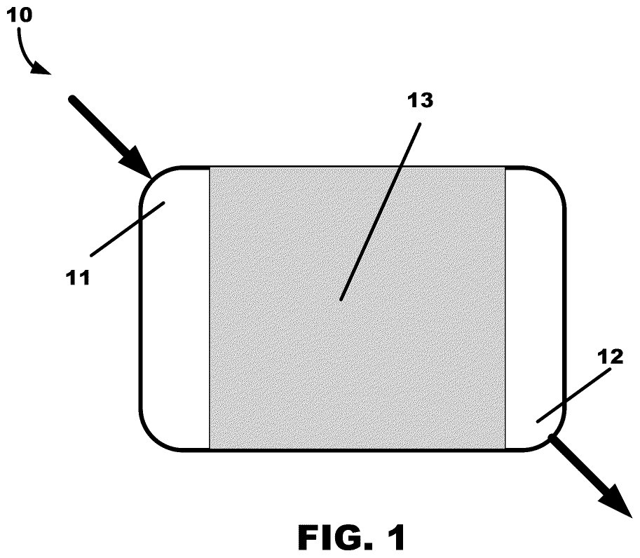

The objective function F in Equation 1 contains a weighted sum of the mutually exclusive design requirements, given by the average reactant concentration f₁ defined in Equation 2 and the flow resistance f₂ defined in Equation 3. The weights w₁ and w₂ control how much the optimization favors designs with a more uniform reactant concentration versus designs with a lower flow resistance, respectively. Within Equation 2 and Equation 3, c represents the reactant concentration, v represents the velocity vector, Ωᵣ represents the reaction domain, and Ω represents the entire design domain, as illustrated in FIG. 1. The microreactor design domain 10 comprises an inlet region 11 at the upper left-hand corner, an outlet region 12 at the bottom right-hand corner, and the reaction domain 13 between the inlet region 11 and the outlet region 12.

Steady-State Dehomogenization

Bioinspired striped patterns were used to dehomogenize the optimized orientation fields into microchannel flow plate designs via the Swift-Hohenberg model. The Swift-Hohenberg model is originally established to study the Rayleigh-Bénard system where convective instability causes rolls and hexagon patterns to emerge as given by the single equation:

$$\frac{\partial u}{\partial t} = - {( {∇}^{2} + {k}^{2} )}^{2} u + ε u + g {u}^{2} - {u}^{3} - 2 {q}^{2} ∇ \cdot ( D ∇ u ) , \qquad ( 4 )$$

The last term in Equation 4 is introduced to the model as a production gradient to permit anisotropic diffusion such that the patterns evolve according to a prescribed orientation field. The anisotropic diffusion tensor (D) is defined using the normalized orientation vector (p=(p₁,p₂)) as follows:

$${φ}_{⊥} = [ \begin{matrix}cos θ & - sin θ \\ sin θ & cos θ\end{matrix} ] [ \begin{matrix}{p}_{1} \\ {p}_{2}\end{matrix} ] = [ \begin{matrix}0 & - 1 \\ 1 & 0\end{matrix} ] [ \begin{matrix}{p}_{1} \\ {p}_{2}\end{matrix} ] = [ \begin{matrix}- {p}_{2} \\ {p}_{1}\end{matrix} ] , \qquad ( 5 )$$

$$\begin{matrix}D ( \overline{φ} ) = {\overline{φ}}_{⊥} ⊗ & {\overline{φ}}_{⊥} = [ \begin{matrix}{\overline{p}}_{2} {\overline{p}}_{2} & - {\overline{p}}_{1} {\overline{p}}_{2} \\ sym . & {\overline{p}}_{1} {\overline{p}}_{1}\end{matrix} ] ,\end{matrix} \qquad ( 6 )$$

where φ̅_{⊥} represents the optimized orientation vector that has been rotated 90°. The vector must be rotated 90° so that the major axis of the striped pattern is aligned with the primary axis of the flow field to create distinct microchannels during the dehomogenization process.

Various design features of the microchannel flow fields can be introduced using the additional variables present in the Swift-Hohenberg model. The variables k and q in Equation 4 were defined as follows,

$$k = \sqrt{\frac{{π}^{2}}{{w}^{2}} - {q}^{2}} , \qquad ( 7 )$$

$$q = α * \frac{π}{w} , \qquad ( 8 )$$

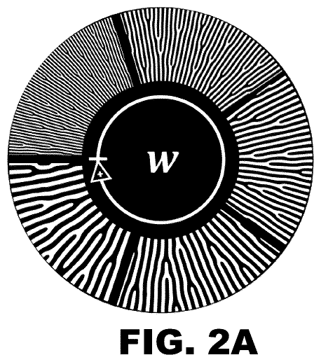

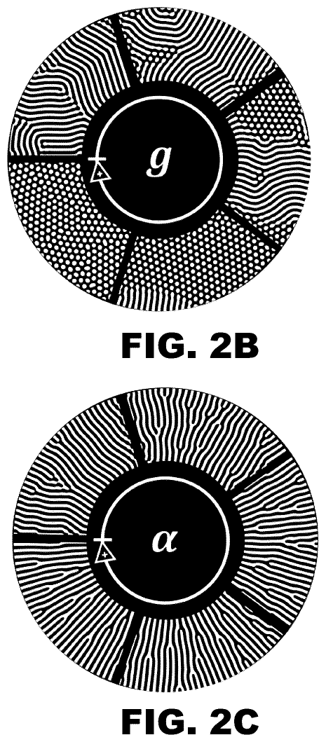

such that the variable w controls the frequency of the pattern that is generated. In the case of striped patterns, larger values of w correspond to wider channels while smaller values correspond to narrower channels, as illustrated in FIG. 2A. In FIGS. 2A through 2C, the arrow indicates the direction of increase for the parameter value. FIG. 2A illustrates a channel width parameter w (prescribed radial orientation), FIG. 2B illustrates a spotted pattern control parameter g (ε is held constant), and FIG. 2C illustrates an anisotropic control parameter a (prescribed radial orientation).

In Equation 8, the variable a controls the level of anisotropy which defines how tightly the patterns must adhere to the prescribed orientation field. For striped patterns, higher anisotropic values correspond to designs with more branching to respect the prescribed orientation field, while lower anisotropic values correspond to designs with more parallel channels, as illustrated in FIG. 2C. It should be noted that the level of anisotropy must fall in the range, 0<α<1, to ensure that the value of k remains real and doesn't become an imaginary number. Finally, the constants ε and g in Equation 4 control should a striped or spotted pattern emerges, as illustrated in FIG. 2B where ε is held constant and g is varied (since g>0 drives the development of spotted patterns).

Due to the transient quality of pattern development in nature, the Swift-Hohenberg model is generally solved in time to capture the temporal dynamics of the system. When applied as a dehomogenization technique, however, the details on exactly how the pattern evolves throughout time is not a priority; all that matters is the final solution. Consequently, when used in this capacity, the temporal process can be skipped by solving the steady-state equation instead. Compared to other pattern generation models (such as, for example, the Brusselator model, the Schnackenberg model, and the Gray-Scott model) the Swift-Hohenberg model is unique because it generates patterns from a single variable equation instead of a system of coupled equations.

In accordance with one or more embodiments, the steady-state Swift-Hohenberg equation is solved by assigning:

$$\frac{\partial u}{\partial t} = 0. \qquad ( 9 )$$

The direct stationary solver is used in combination with the Newton-Raphson method for the nonlinear component of the equation. The solution is initialized as u₀≈\sqrt{ε}. There are two key benefits of solving a steady-state pattern generation model over a transient model. First, the steady-state model guarantees convergence of the solution. Second, the steady-state model is generally more computationally efficient. This is because there is no need to iterate through time to attain the final solution. In particular, the computational speed up increases as the required time step in the transient model decreases.

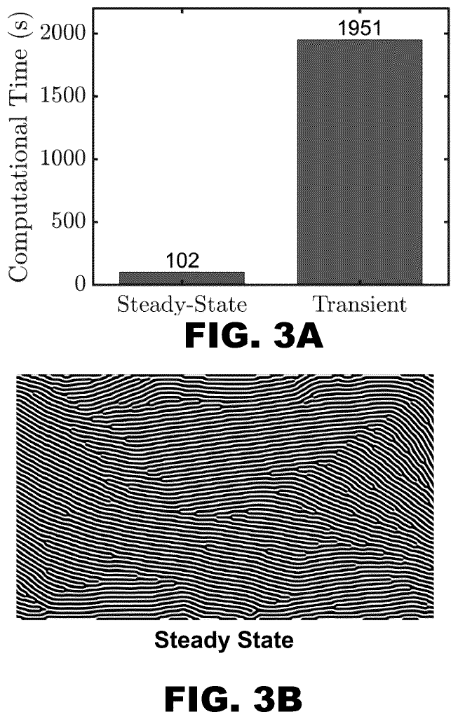

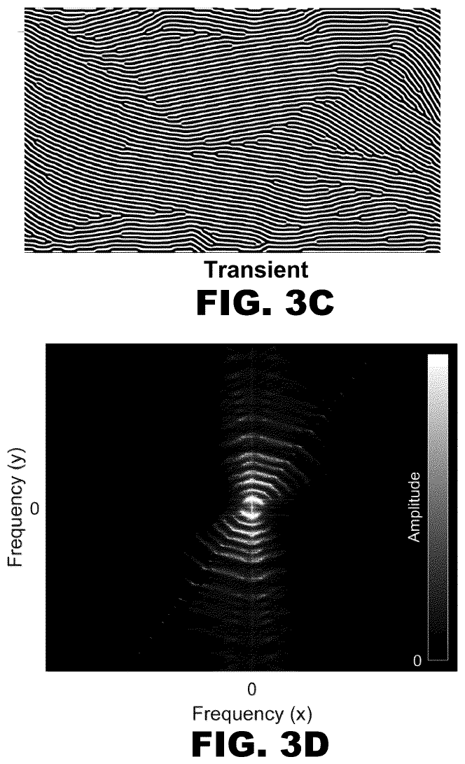

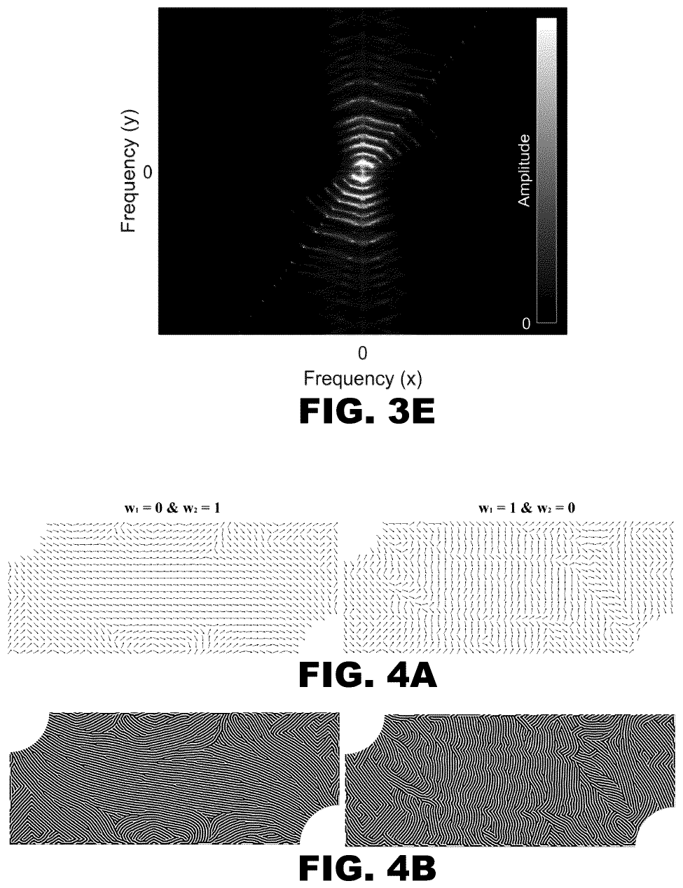

To support the advantages stated herein, the steady-state solution is compared to the transient solution. FIGS. 3A through 3E illustrate a comparison of steady-state versus transient Swift-Hohenberg model. FIG. 3A is a chart representing computational time, and FIGS. 3B and 3C illustrate a steady-state spatial domain and a transient spatial domain, respectively. FIGS. 3D and 3E illustrate a steady-State frequency domain, and a transient frequency domain, respectively.

First, a two-dimensional striped pattern is generated using each of the models. The transient model is executed until the time domain reaches t=500 when the observed pattern change became negligible and the steady-state model is executed until convergence is achieved. The final solutions generated in the spatial domain maintained structural similarities but with slightly different branching locations, as illustrated in FIGS. 3B and 3C.

FIG. 3A illustrates a comparison of the computational time for the two models, illustrating an order of magnitude difference between the steady-state solution (102 seconds) and the transient solution (1,951 seconds). Next, a two-dimensional Fourier transform analysis is executed to verify the statistical similarities between the patterns produced by each model.

FIGS. 3D and 3E illustrate the steady-state and transient solutions in the frequency domain, respectively. Within this domain, the Fourier transform analysis illustrates that the frequencies and amplitudes of the structures generated are nearly identical. These results are acceptable, because solution uniqueness is not guaranteed in the spatial domain but in the frequency domain the structures established statistical equivalence between the steady-state and transient models. Therefore, the steady-state Swift-Hohenberg model can be applied to the dehomogenization process with confidence that the proper solutions are being generated.

Results

A Pareto front for the design of multi-objective microreactor flow fields is developed by executing a grid search on the weighting scheme defined within the objective function of the optimization problem. The unit cell method described in U.S. patent application Ser. No. 17/407,657 is utilized to determine the permeability of the porous media assumed in the optimization problem and may be applied to multiple different sized channel design regions in the reactor, as desired. The weights were specified with a linear interval spacing of 0.02 according to the following:

0≤w₁≤1

w₂=1−w₁, (10)

where w₁ controls the reaction uniformity and w₂ controls the flow resistance. The limits of the weighting interval represent a single objective optimization problem, because one of the weights becomes zero. These results represent the bounds for the multi-objective solution space.

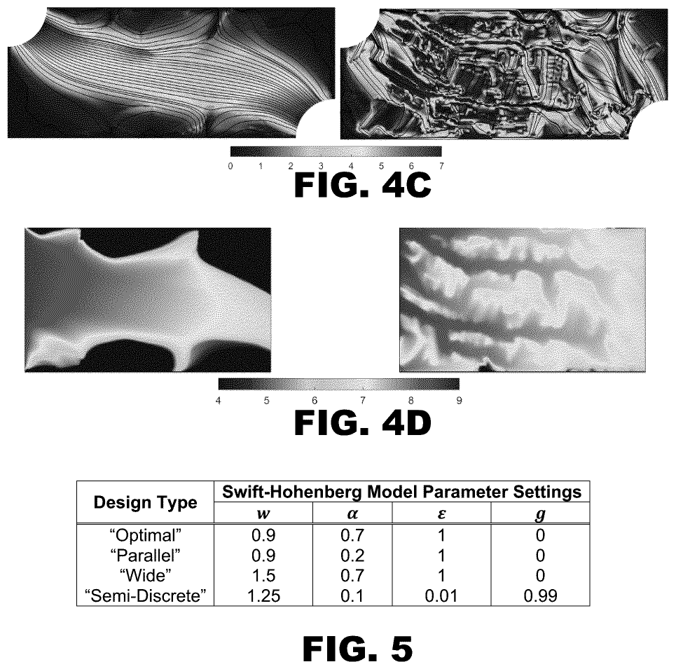

FIGS. 4A through 4E respectively illustrate microreactor flow field designs derived using single-objective optimization, in accordance with one or more embodiments set forth, described, and/or illustrated herein. FIG. 4A illustrates optimized orientation fields derived from the homogenization-based optimization routine in accordance with one or more embodiments. FIG. 4B illustrates diffusion-based dehomogenized microreactor flow fields derived from the homogenization-based optimization routine in accordance with one or more embodiments. FIG. 4C illustrates a velocity field derived from the homogenization-based optimization routine in accordance with one or more embodiments. FIG. 4D illustrates a reactant concentration field derived from the homogenization-based optimization routine in accordance with one or more embodiments.

FIGS. 4A and 4B respectively illustrate the optimized orientation fields and resultant dehomogenized microchannel designs at the limits of the design space. In the case where only the flow resistance is minimized, a clear path of parallel channels connecting the inlet region to the outlet region emerges. In contrast, when only the reaction variability is minimized, vertical channels emerge to impede the natural flow of the fluid and disperse it throughout the flow plate. FIGS. 4C and 4D illustrates the corresponding velocity and reactant concentration fields for the bounding designs. When the flow resistance is minimized, a velocity field with smooth streamlines emerges, but at the expense of a non-uniform reactant concentration field. Conversely, when the reaction variability is minimized, a chaotic velocity field emerges to permit a more uniform reactant concentration field, but at the expense of a higher flow resistance.

The microchannel flow field designs, as illustrated in FIG. 4B, are created to prioritize the proper channel orientation by assigning the anisotropic parameter (a) a high value. In addition, the design parameters are allocated such that the resultant flow channel dimensions are representative of the assumed unit cell dimensions during the homogenization-based optimization. Therefore, the computer-implemented steady-state dehomogenization design method in accordance with one or more embodiments took on the parameter settings represented by the “optimal” design set forth in FIG. 5.

Pareto Front

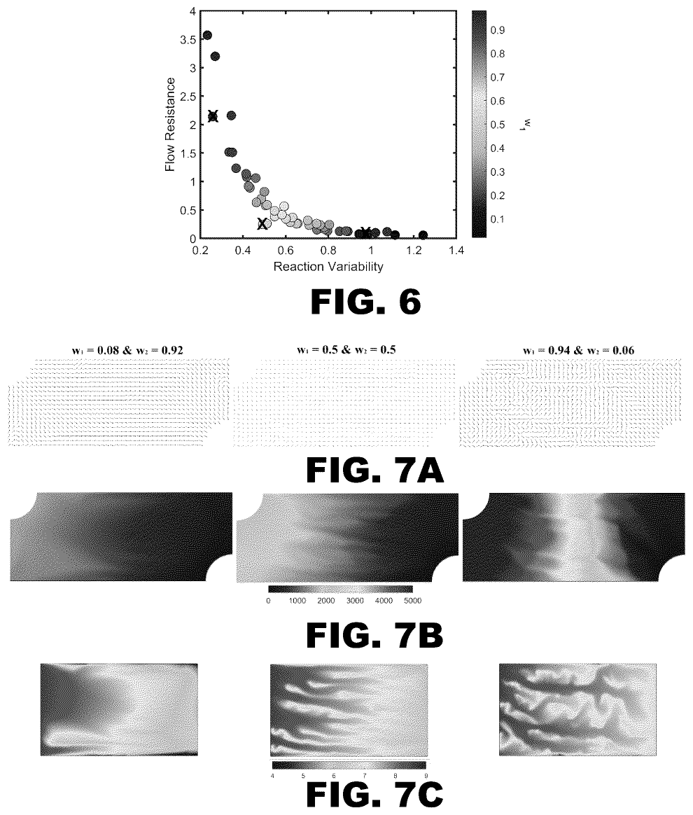

FIG. 5 illustrates the Pareto front for the multi-objective optimization problem. The Pareto front illustrates how the flow resistance and reaction variability change as the objective function's weighting scheme is altered in the optimization problem. To gain a more in-depth understanding of how the flow field transforms throughout the front, three designs were selected as designated by “X” in FIG. 6. The colormap represents the value of the reaction variability weight. Each “X” represents the designs that were studied in the following figures

The optimized orientation field, pressure field, and reactant concentration field for the selected designs are illustrated in FIGS. 7A through 7C. Each column represents a different combination of the objective function weights. FIG. 7A illustrates an optimized orientation field, FIG. 7B represents a pressure field, and FIG. 7C represents a reactant concentration field. As the reaction uniformity weight (w₁) increases, the reactant concentration field becomes more uniform as illustrated in FIG. 7C. FIG. 7B, however, illustrates that reaction uniformity comes at the cost of a significant increase in the pressure drop. The solution that best balances these two opposing design objectives is the weighting scheme given by w₁=w₂=0.5.

FIGS. 7A through 7C illustrates how this solution maintains a low pressure drop while yielding a more uniform reaction concentration field. The computer-implemented steady-state dehomogenization design method is used to convert the selected optimized orientation fields into distinct microchannel flow fields.

Due to the rapid dehomogenization feature of the computer-implemented steady-state dehomogenization design method in accordance with one or more embodiments, a generative design approach may be deployed to greatly expand the overall number of possible solutions. Therefore, the design parameters in the Swift-Hohenberg model are adjusted to permit the generation of three additional and distinctly different microchannel geometries.

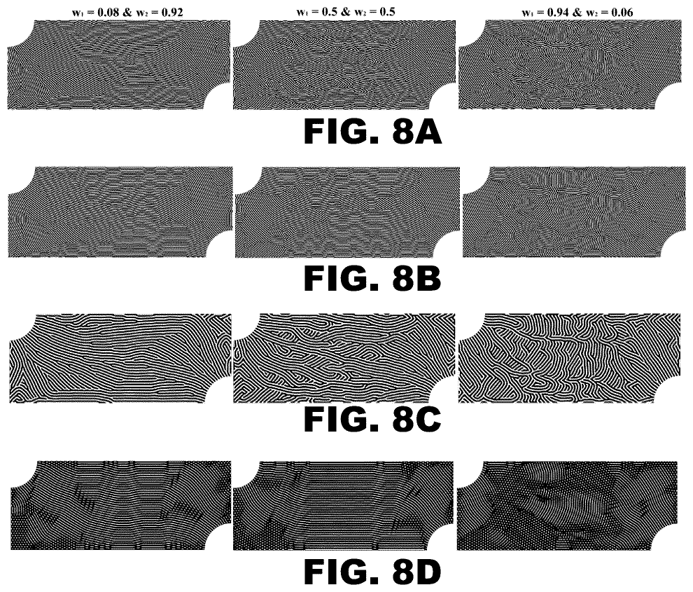

FIGS. 8A through 8D illustrate diffusion-based dehomogenized microchannel flow field designs for the three different weighting schemes represented by “X” in the Pareto front, in accordance with one or more embodiments. Each column represents a different combination of the objective function weights. Each row represents a different design type defined by the Swift-Hohenberg parameter settings.

FIG. 8A illustrates final microchannel architectures for the “optimal” design described in FIG. 5. A comparison of the three designs illustrates that as the reaction uniformity weight (w₁) increases, more channels emerge perpendicular to the flow path to encourage a greater dispersion of the reactant fluid throughout the flow field. FIG. 8B illustrates a “parallel” design, FIG. 8C illustrates a “wide” design, and FIG. 8D illustrates a “semi-discrete” design.

FIG. 8B illustrates the dehomogenized “parallel” designs for the three different weighting schemes highlighted in the Pareto front. The resultant flow fields favor parallel channels, but at the expense of smoothing out some of the details found in the “optimal” design configurations. Next, a “wide” design is established by increasing the channel width parameter (w) to foster designs at a larger length scale. FIG. 8C illustrates the dehomogenized “wide” designs for the three different weighting schemes highlighted in the Pareto front. The resultant flow fields respect the optimized orientation while introducing the potential of larger channel geometries into the design space. Finally, a “semi-discrete” design is established by adjusting the pattern-type control parameters (ε and g) and reducing the anisotropic parameter (α) to encourage the generation of discrete structures. FIG. 8D illustrates the dehomogenized “semi-discrete” designs for the three different weighting schemes highlighted in the Pareto front. The resultant flow fields seem to favor discrete features in locations where the orientation is not ideal for easily producing parallel channels. The number of generative designs can be efficiently further expanded due to the proposed rapid steady-state dehomogenization technique. It is noted, however, that the multiphysics performance of expanded generative designs should be separately evaluated since they often violate porous media optimization assumptions. In the “parallel” case, the optimized orientation is not strictly followed after dehomogenization. In the “wide” and “semi-discrete” cases, the assumed unit cell geometry is not recovered.

Computational Cost

In total, two-hundred microchannel flow field designs were created using the steady-state dehomogenization technique in accordance with one or more embodiments. The solutions spanned the full range of objective function weights defined by the grid search, in addition to the four distinctly different categories of design features controlled by the parameter settings in the Swift-Hohenberg model. For each design category, fifty structures were generated representing every point identified in the Pareto front and the limits of the design space.

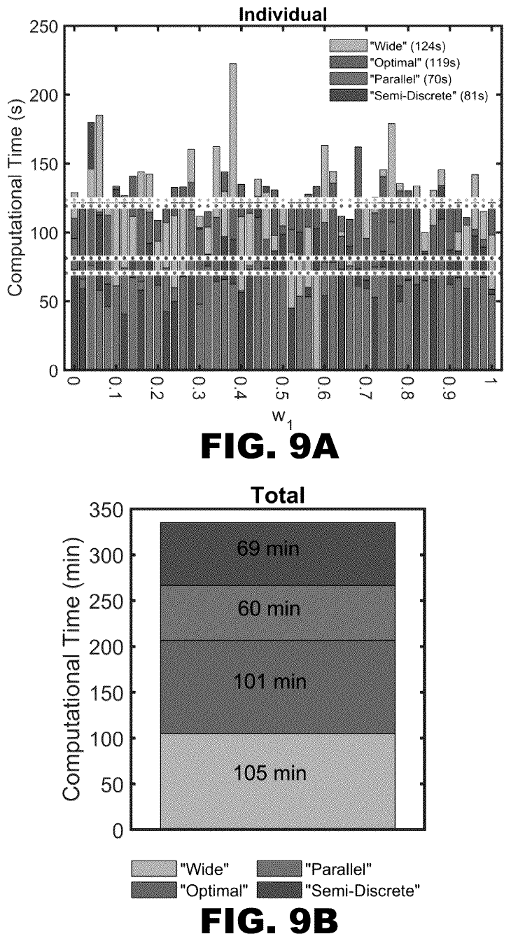

FIG. 9A illustrates computational time required to perform the steady-state dehomogenization process for each individual design and each design category according to the reaction variability weight w₁. The color of the bars represents the design type. The dotted lines represent the average computational time for each design type. FIG. 9B illustrates total computational time required to generate all fifty designs for each design type represented by bar color.

The average time required to produce a single dehomogenized flow field design is one hundred nineteen seconds for the “optimal” setting, seventy seconds for the “parallel” setting, one hundred twenty-four seconds for the “wide” setting, and eighty-one seconds for the “semi-discrete” setting. The average computational time for each category is represented by the dotted lines in FIG. 9A.

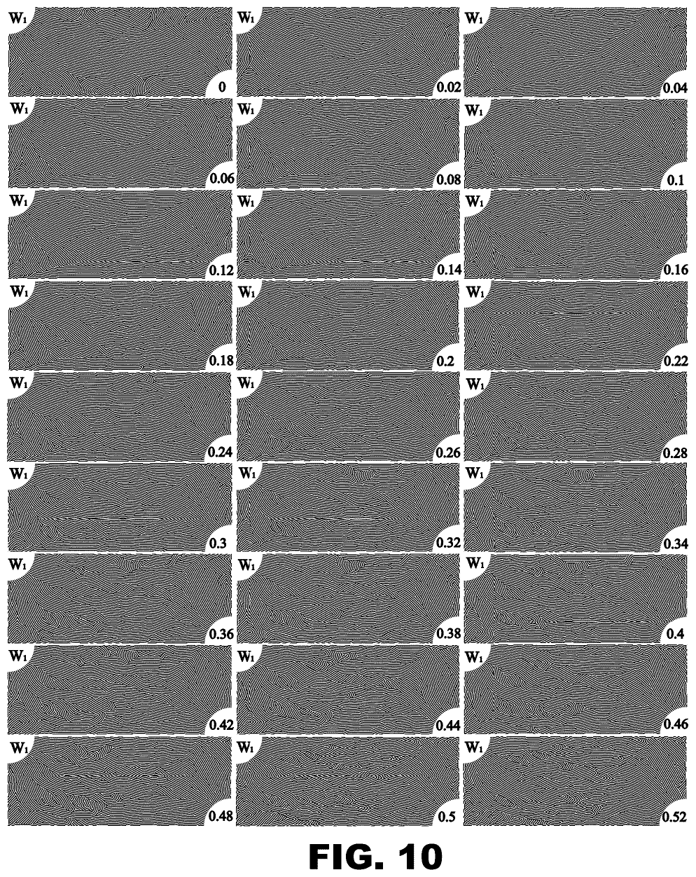

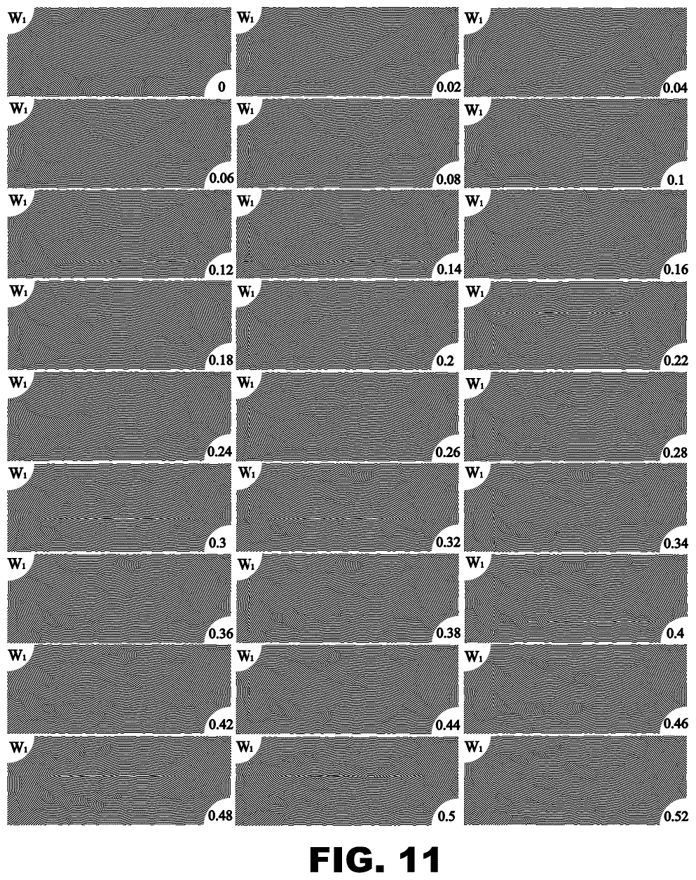

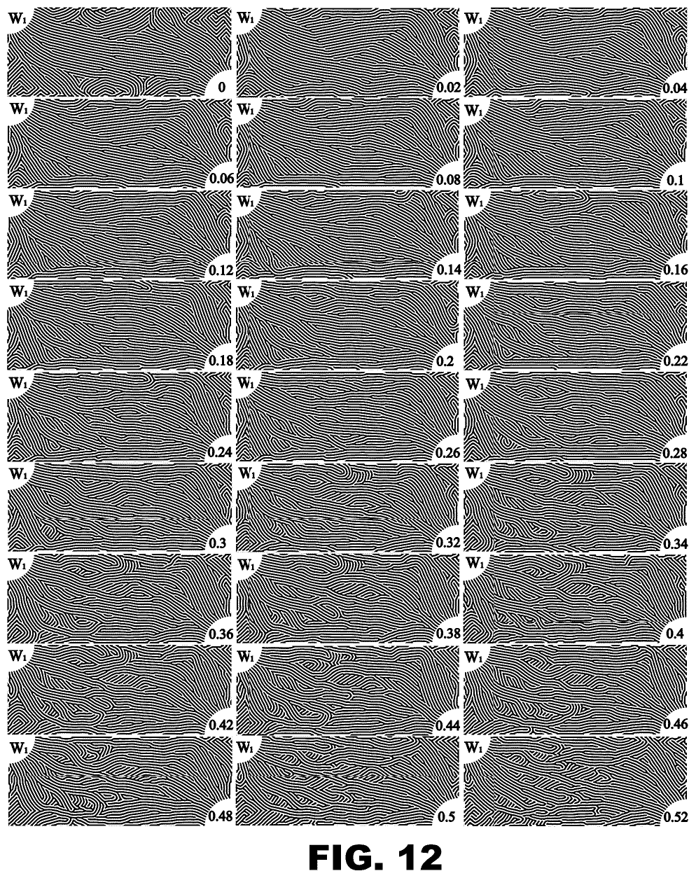

In general, larger values of the anisotropic parameter (α) required slightly longer computational times due to the heightened orientation requirement that had to be satisfied in the final design. FIG. 9B illustrates the total time required to generate all fifty solutions for each category of parameter settings. Altogether, two hundred unique and distinctly different microchannel flow fields were created in just over 5.5 hours, rendering the steady-state dehomogenization technique a viable tool in generative design applications. FIGS. 10 through 12 are example microchannel flow field designs.

Multi-Zone Microreactor Designs

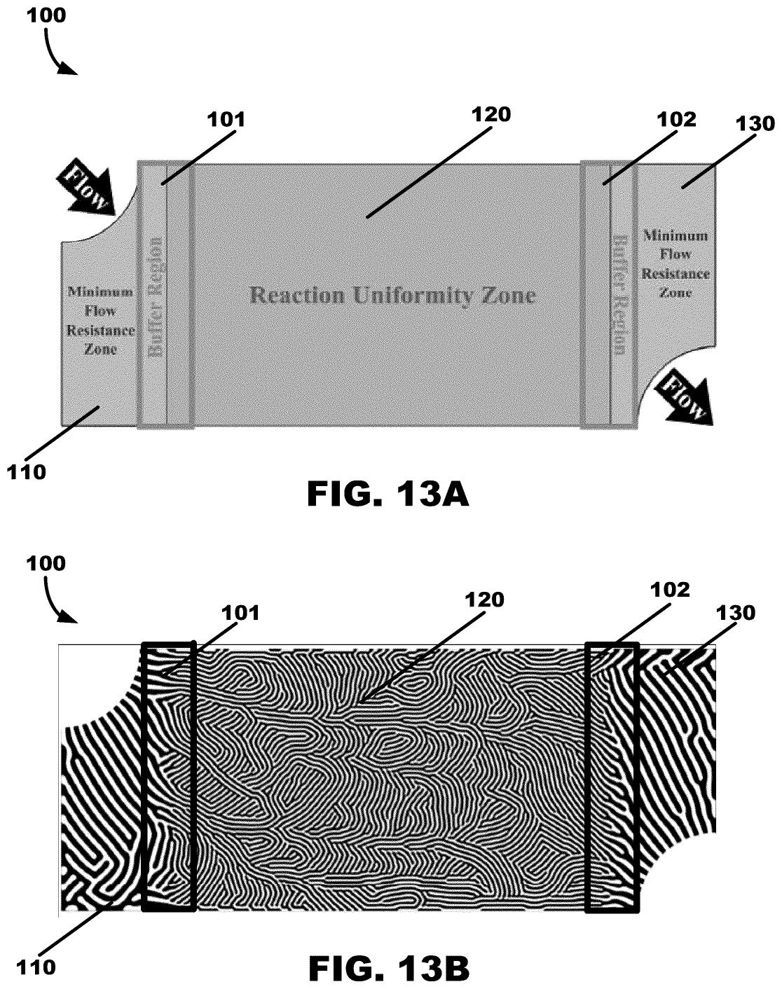

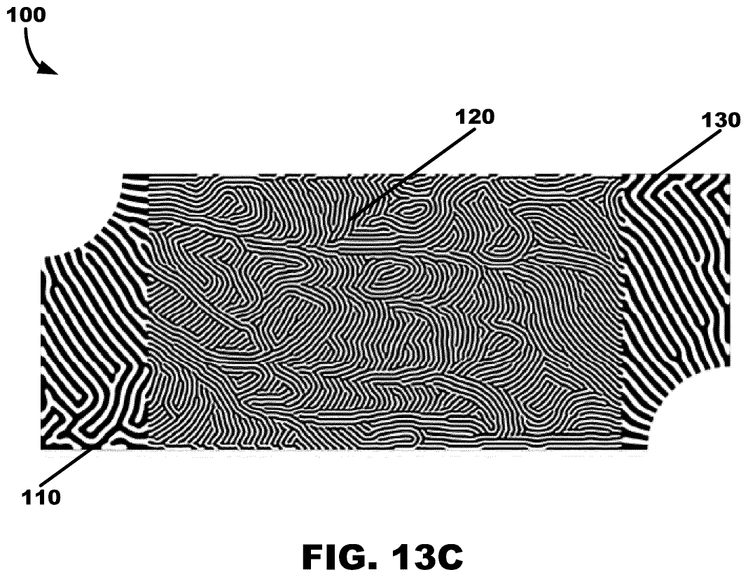

During the bioinspired, diffusion-based dehomogenization process in accordance with one or more embodiments, the designer has an added layer of control and flexibility that can be exploited to create novel multi-zone microreactors with tunable functionality. For example, FIGS. 13A through 13C illustrate multi-zone microreactor flow field designs.

FIG. 13A illustrates a microreactor flow field design 100 having a plurality of specific flow field zones that include “(10)” 110, “Zone 2” 120, and “Zone 3” 130 that are identifiable based on different, user-defined physical objectives. In the illustrated embodiment, “Zone 1” 110 comprises an inlet region having a performance objective of minimum flow resistance, “Zone 2” 120 comprises a reaction region having a performance objective of reaction uniformity, and “Zone 3” 130 comprises the outlet region having a performance objective of minimum flow resistance.

To address the localized requirements, a spatially varying channel width parameter can be defined to promote wider channels in the minimum flow resistance regions and narrower channels in the reaction uniformity zone. In addition, buffer regions can be introduced to facilitate a gradual fluid flow transition at a fluidic interface between zones, particularly those zones that have different channel widths. For instance, the microreactor flow field design 100 of FIG. 13A and the corresponding multi-zone dehomogenized flow field design of FIG. 13B includes a first buffer region 101 located at a fluidic interface between “Zone 1” 110 and “Zone 2” 120, and a second buffer region 102 located at a fluidic interface between “Zone 2” 120 and “Zone 3” 130. FIG. 13C illustrates a multi-zone dehomogenized flow field design based on the microreactor flow field design 100 but does not incorporate any buffer regions. It is worth noting that the feature transition is seamless between the neighboring/adjacent zones, even should a buffer region not be included in the design. This characteristic is unique to the Swift-Hohenberg model and can be more challenging to achieve without a diffusion-based technique; particularly when there is a hard boundary between zones.

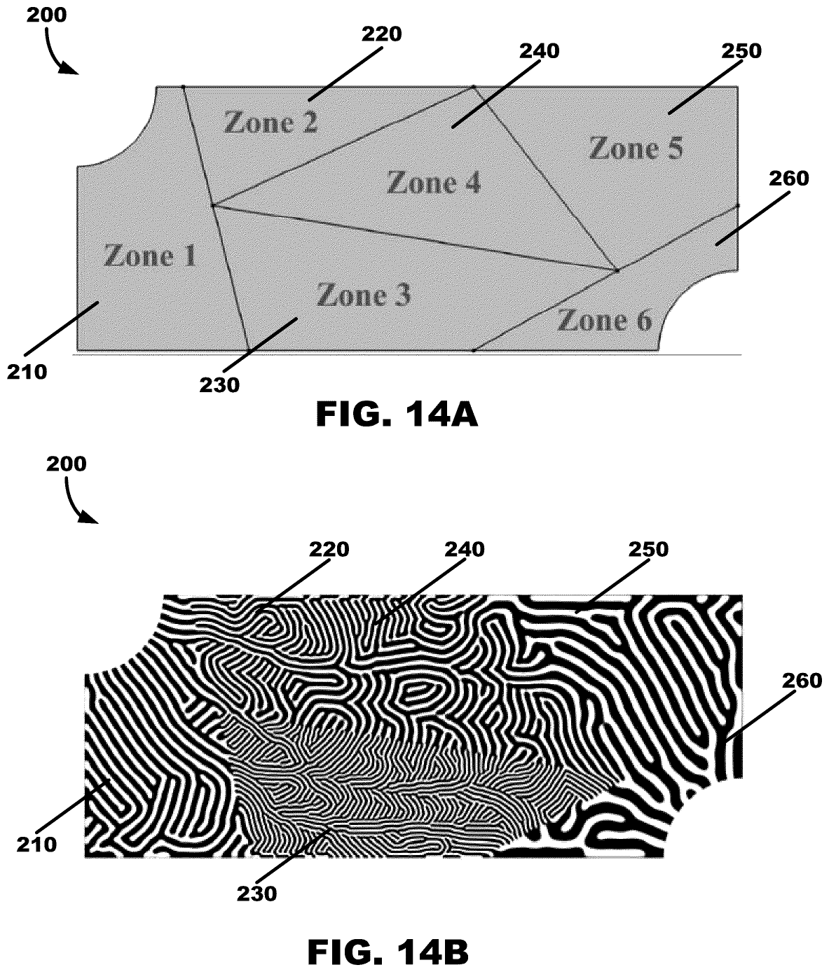

To further highlight the versatility of the approach, FIGS. 14A and 14B respectively illustrate a unique six-zone microreactor flow field design 200 comprising subdomains having a plurality of flow field zones that includes “Zone 1” 210, “Zone 2” 220, “Zone 3” 230, “Zone 4” 240, “Zone 5” 250, and “Zone 6” 260 that vary in shape, size, and channel width.

FIG. 14A illustrates the location of each zone and description within the microreactor flow field design 200, while FIG. 14B illustrates the patterned microreactor structure comprising large channels for product input/output, small channels for reaction uniformity, and buffer regions between neighboring/adjacent zones. In accordance with one or more embodiments, dehomogenization is achieved through such a multi-zone design where channel widths and geometries within a given zone are optimized based on physical objectives and/or performance objectives of each respective zone within the flow field. For example, the reactant input flow and output flow can be optimized to minimize flow resistance upon entry to and exit from the reactor. Moreover, a reaction uniformity zone having smaller microchannels that ensure optimal reaction yield and an optional buffer region can be included between proposed domains/zones in order to ensure seamless reactant transition between neighboring/adjacent zones.

This type of flow field architecture set forth, described, and/or illustrated in this disclosure is contemplated to have particular industrial application in lab-on-a-chip applications where different channel designs and scales are required to meet the desired physical objectives and performance objectives. For example, the flow field could be constructed such that “Zone 1” 210 comprises the inlet region, “Zone 2” 220 and “Zone 3” 230 comprise mixing regions, “Zone 4” 240 comprises the reaction region, “Zone 5” 250 comprises the drainage region, and “Zone 6” 260 comprises the outlet region. Due to the computational efficiency of the steady-state dehomogenization process in accordance with one or more embodiments, a generative design approach may be implemented to explore the vastness of the multi-zone design domain for an array of applications. It should be noted that both the zone partitioning and the spatially varying design features can also be fine-tuned within an additional optimization framework.

Ultimately, the steady-state dehomogenization process in accordance with one or more embodiments produces less undesirable randomness in channel widths. For example, each zone can have a specific configuration in which each region or zone, namely, “Zone 1” 210, “Zone 2” 220, “Zone 3” 230, “Zone 4” 240, “Zone 5” 250, and “Zone 6” 260, has uniform channel widths in meeting a specified performance objective. Alternatively, each zone can have a configuration in which each zone, namely, “Zone 1” 210, “Zone 2” 220, “Zone 3” 230, “Zone 4” 240, “Zone 5” 250, and “Zone 6” 260, has specific channel widths that vary with respect to other zones and which are tailored to meet a specific performance objective.

Microreactor Flow Field Configuration

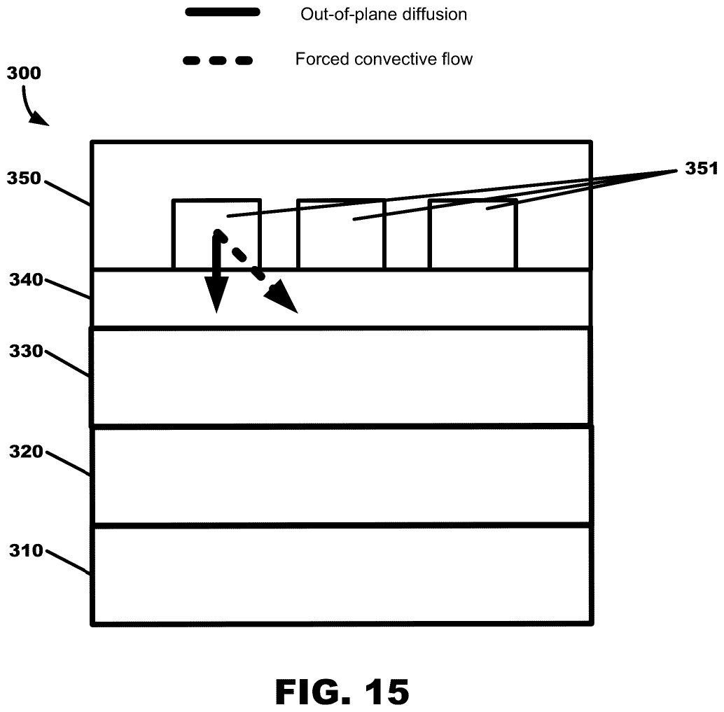

FIG. 15 illustrates a cross-sectional view of a fuel cell (FC) 300 that utilizes a microreactor flow field in combination with a porous gas diffusion layer. The porous layer permits out-of-plane convective flow should a dead end be encountered by the reactant. The FC 300 has a multi-layered configuration comprising a membrane electrode assembly (MEA) layer 310, one or more catalyst layers 320, a microporous layer 330, a microporous gas diffusion layer (GDL) 340, and a metal bipolar plate 350 having one or more flow channels defined by a multi-zone microreactor flow field 351. When dead ends are encountered within the flow field, the reactant will be forced to flow under the rib and into the porous gas diffusion layer. As a result, the multi-zone microreactor flow field designs may exploit some of the advantages associated with interdigitated flow field geometries, such as enhanced water removal techniques.

Computer-Implemented Methods

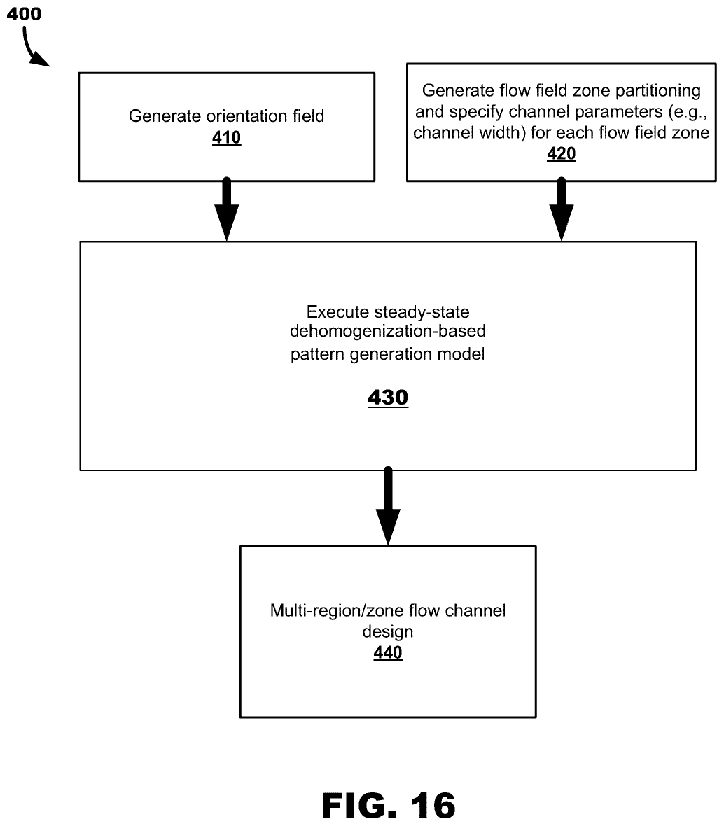

As illustrated in FIG. 16, in accordance with one or more embodiments, a flow diagram 400 for the steady-state dehomogenization-based computer-implemented method set forth, described, and/or illustrated herein. At process block 410, an orientation field for the microreactor is generated based upon predetermined performance objectives for the microreactor. At process block 420, the flow field is partitioned into a plurality of regions/zones (See, FIGS. 13A and 14A) based upon predetermined performance objectives for the microreactor. Alternatively, this disclosure contemplates generating a partitioned flow field manually. At process block 430, the orientation field and the partitioned flow field design are used as input values to execute a dehomogenization-based pattern generation model. At process block 440, a multi-zone microreactor flow field design is output in response to execution of the dehomogenization-based pattern generation model.

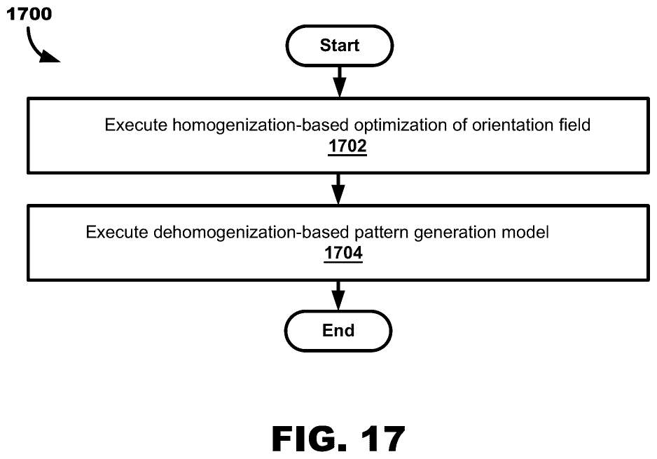

FIGS. 17 through 19 respectively illustrate flowcharts of example computer-implemented methods 1700, 1800, and 1900 of designing a microreactor flow field, in accordance with one or more embodiments. Each example computer-implemented method is to yield an optimized microreactor flow field design having channel configurations that are tailored to meet specific performance objectives based upon weighted factors related to reactant concentration and fluid flow resistance.

The flowchart of each respective example computer-implemented methods 1700, 1800, and 1900 corresponds in whole or in part to the schematic illustrations of the method illustrated in FIG. 16 which is set forth and described herein. In accordance with embodiments, each example computer-implemented method 1700, 1800, and 1900 may be implemented, for example, using logic instructions (e.g., software), configurable logic, fixed-functionality hardware logic, etc., or any combination thereof that are stored in at least one non-transitory machine- or computer-readable storage medium. Examples of suitable non-transitory machine- or computer-readable storage medium include, but are not limited to: RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), field programmable gate arrays (FPGAs), complex programmable logic devices (CPLDs), fixed-functionality logic hardware using circuit technology such as, for example, application specific integrated circuit (ASIC), complementary metal oxide semiconductors (CMOS) or transistor-transistor logic (TTL) technology, registers, magnetic disks, optical disks, hard drives, or any other suitable storage medium, or any combination thereof. As an example, software executed on one or more computer devices or computer systems may provide functionality described or illustrated herein.

Each computing device respectively includes one or more processors. In particular, software executing on one or more computer devices or computer systems may perform one or more fabrication or processing blocks of each example computer-implemented method 1700, 1800, and 1900 set forth, described, and/or illustrated herein or provides functionality described or illustrated herein.

In the illustrated example embodiment of FIG. 17, illustrated process block 1702 includes generating, via a gradient-based anisotropic porous media process, an optimized spatially varying orientation field for user-defined zones in a microreactor flow field.

The method 1700 may then proceed to illustrated process block 1704, which includes executing, in response to the homogenization-based optimization, a dehomogenization-based pattern generation model of the orientation field to generate a continuous microreactor flow field.

The method 1700 can terminate or end after execution of illustrated process block 1704.

In accordance with illustrated process block 1704, the dehomogenized optimization uses a steady-state, single-variable model.

In accordance with illustrated process block 1704, the dehomogenization-based pattern generation uses the Swift-Hohenberg model.

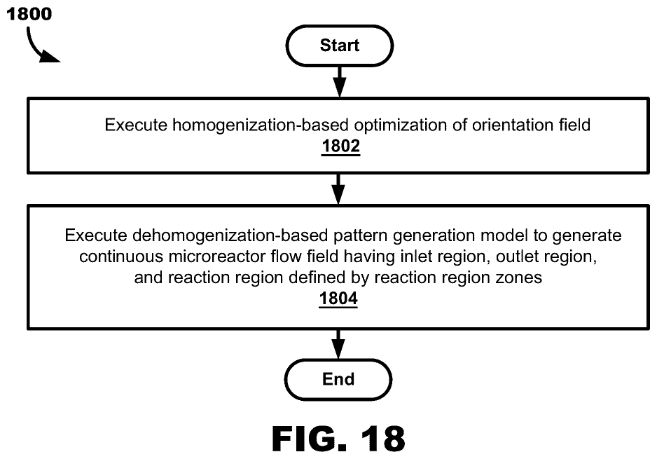

In the illustrated example embodiment of FIG. 18, illustrated process block 1802 includes generating, via a gradient-based anisotropic porous media process, an optimized spatially varying orientation field for user-defined zones in a microreactor flow field.

The method 1800 may then proceed to illustrated process block 1804, which includes executing, in response to the homogenization-based optimization, a dehomogenized optimization model of the orientation field to generate a continuous microreactor flow field having an inlet region, an outlet region, and a reaction region defined by a plurality of reaction region zones fluidically connected to the inlet region and the outlet region.

The method 1800 can terminate or end after execution of illustrated process block 1804.

In accordance with illustrated process block 1804, the dehomogenization-based pattern generation model uses a steady-state, single-variable model.

In accordance with illustrated process block 1804, the dehomogenization-based pattern generation model uses the Swift-Hohenberg model.

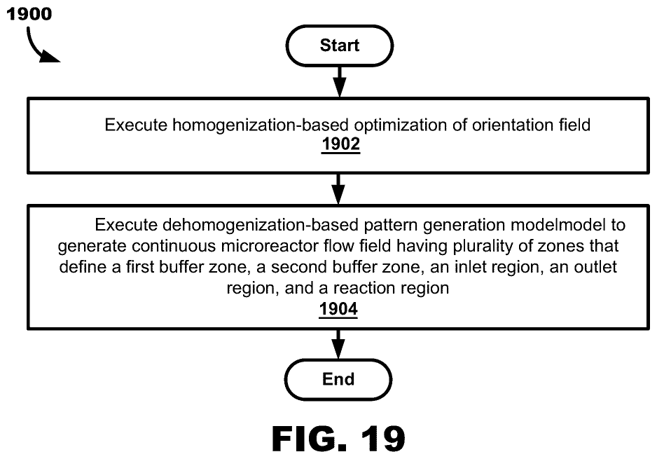

In the illustrated example embodiment of FIG. 19, illustrated process block 1902 includes generating, via a gradient-based anisotropic porous media process, an optimized spatially varying orientation field for user-defined zones in a microreactor flow field.

The method 1900 may then proceed to illustrated process block 1904, which includes executing, in response to the homogenization-based optimization, a dehomogenization-based pattern generation model to generate a continuous microreactor flow field having a plurality of zones that define an inlet region, an outlet region, and a reaction region, a first buffer region to facilitate a fluid flow transition at a fluidic interface between zones of different channel widths at the inlet region and the reaction region, and a second buffer region to facilitate a fluid flow transition at a fluidic interface between zones of different channel widths at the reaction region and the outlet region.

The method 1900 can terminate or end after execution of illustrated process block 1904.

In accordance with illustrated process block 1904, the dehomogenization-based pattern generation model uses a steady-state, single-variable model.

In accordance with illustrated process block 1904, the dehomogenization-based pattern generation model uses the Swift-Hohenberg model.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the one or more embodiments can be implemented in a variety of forms. Therefore, while the embodiments are set forth, illustrated, and/or described in connection with particular examples thereof, the true scope of the embodiments should not be so limited since other modifications will become apparent to the skilled practitioner upon a study of the drawings, specification, and claims.

What is claimed is:

1. A microreactor, comprising:
a fluid flow field having an inlet region, an outlet region, and a reaction region defined by a plurality of reaction region zones fluidically connected to the inlet region and the outlet region.

2. The microreactor of claim 1, wherein the inlet region is defined by a first zone that comprises a plurality of microchannels having spatially-varying first channel widths.

3. The microreactor of claim 2, wherein the first channel widths correspond to a predefined fluid flow resistance performance objective through the inlet region.

4. The microreactor of claim 1, wherein the outlet region is defined by a second zone that comprises a plurality of microchannels having spatially-varying second channel widths.

5. The microreactor of claim 4, wherein the second channel widths correspond to a predefined fluid flow resistance performance objective through the outlet region.

6. The microreactor of claim 1, wherein each reaction zone in the reaction region zones comprises a plurality of microchannels has spatially-varying third channel widths.

7. The microreactor of claim 6, wherein the third channel widths correspond to a predefined fluid flow resistance performance objective through the reaction region.

8. A microreactor, comprising:
a fluid flow field having a plurality of zones that define an inlet region, an outlet region, and a reaction region, a first buffer region to facilitate a fluid flow transition at a fluidic interface between zones of different channel widths at the inlet region and the reaction region, and a second buffer region to facilitate a fluid flow transition at a fluidic interface between zones of different channel widths at the reaction region and the outlet region.

9. The microreactor of claim 8, wherein the inlet region is defined by a first zone that comprises a plurality of microchannels having spatially-varying first channel widths.

10. The microreactor of claim 9, wherein the first channel widths correspond to a predefined fluid flow resistance performance objective through the inlet region.

11. The microreactor of claim 8, wherein the outlet region is defined by a second zone that comprises a plurality of microchannels having spatially-varying second channel widths.

12. The microreactor of claim 11, wherein the second channel widths correspond to a predefined fluid flow resistance performance objective through the outlet region.

13. The microreactor of claim 8, wherein each reaction zone in the reaction region zones comprises a plurality of microchannels has spatially-varying third channel widths.

14. The microreactor of claim 13, wherein the third channel widths correspond to a predefined fluid flow resistance performance objective through the reaction region.

15. A computer-implemented method of designing a microreactor flow field, the computer-implemented method comprising:
by one or more computing devices having one or more processors:
generating, via a gradient-based anisotropic porous media process, an optimized spatially varying orientation field for user-defined zones in a microreactor flow field; and
executing, in response to the homogenization-based optimization, a dehomogenization-based pattern generation model to generate a continuous microreactor flow field having spatially-varying channel widths.

16. The computer-implemented method of claim 16, wherein the dehomogenization-based pattern generation model uses a steady-state, single-variable model.

17. The computer-implemented method of claim 15, wherein the dehomogenization-based pattern generation model uses the Swift-Hohenberg model.

18. The computer-implemented method of claim 15, wherein execution of the dehomogenization-based pattern generation model generates a continuous microreactor flow field having a plurality of flow field zones that correspond to pre-defined performance objections.

19. The computer-implemented method of claim 15, wherein the plurality of flow field zones are generated to have a gradual fluid flow transition at a fluidic interface between adjacent zones.

20. The computer-implemented method of claim 15, wherein the plurality of flow field zones are generated to vary in shape and size.
